(19) United States
(12) Patent Application Publication
(10) Pub. No.: US 2026/0095625 A1
(43) Pub. Date: Apr. 2, 2026

(54) VIDEO DISPLAY SYSTEM AND AUTOMATIC RECOVERY METHOD FOR VIDEO DISPLAY SYSTEM

(71) Applicant: Sharp Display Solutions, Ltd., Tokyo (JP)

(72) Inventor: Takashi MIKURIYA, Tokyo (JP)

(21) Appl. No.: 19/410,651

(22) Filed: Dec. 5, 2025

Related U.S. Application Data
(63) Continuation of application No. PCT/JP2023/023665, filed on Jun. 26, 2023.

(51) Int. Cl. H04N 21/45; H04N 21/433

(52) U.S. Cl. CPC H04N 21/4518; H04N 21/433

(57) ABSTRACT

A video display system includes a plurality of video display devices and a control system that controls the plurality of video display devices, and each of the plurality of video display devices includes a storage area that stores a log when the own video display device receives a control command transmitted from the control system; and a monitor that monitors the logs stored in the storage areas of the other video display devices, and when the monitor recognizes that a log corresponding to the logs stored in the storage areas of the other video display devices is not stored in the storage area of the own video display device, a video display device in control command reception failure state recognized as not having the stored log requests a video display device in control command reception success state other than the video display device in control command reception failure state among the plurality of video display devices, to transmit the control command received by the video display device in control command reception success state, recovers from a control command reception failure state using the control command, and makes a setting of the own video display device the same as a setting of the video display device in control command reception success state.

### TECHNICAL FIELD

The present invention relates to a video display system and an automatic recovery method for the video display system.

### BACKGROUND ART

Patent document 1 describes an environment in which a personal computer (PC) and a plurality of projectors are connected. In a technology described in patent document 1, a detection device (PC) sends a synchronization signal, and each device (projector) that receives the synchronization signal determines an input signal reception time depending on the synchronization signal and sends the input signal reception time together with device information to the detection device, and the detection device receives the sent input signal reception time and estimates a group from the device information including the received input signal reception time.

### CITATION LIST

### Patent Document

Patent document 1: Japanese Unexamined Patent Application, First Publication No. 2018-101328

### SUMMARY OF INVENTION

### Technical Issue

However, in the technology described in Patent Literature 1, a specific projector or a group of projectors can be recognized from among the plurality of projectors, but when recovery of a certain projector among the plurality of projectors becomes necessary, the projector cannot be appropriately recovered.

In view of the above-described points, an object of the present invention is to provide a video display system and an automatic recovery method for the video display system capable of appropriately performing recovery of a video display device requiring recovery when there is the video display device requiring recovery among a plurality of video display devices controlled by a control system.

### Solution to Problem

A video display system according to an aspect of the present invention is a video display system including a plurality of video display devices and a control system configured to control the plurality of video display devices, wherein each of the plurality of video display devices includes a storage area configured to store a log when the own video display device receives a control command transmitted from the control system; and a monitor configured to monitor the logs stored in the storage areas of the other video display devices, and when the monitor recognizes that the log corresponding to the logs stored in the storage areas of the other video display devices is not stored in the storage area of the own video display device, a video display device in control command reception failure state that is a video display device recognized as not having the stored log corresponding to the other video display devices requests a video display device in control command reception success state that is a video display device other than the video display device in control command reception failure state among the plurality of video display devices, to transmit the control command received by the video display device in control command reception success state, recovers from a control command reception failure state using the control command transmitted from the video display device in control command reception success state to the video display device in control command reception failure state, and makes a setting of the video display device in control command reception failure state the same as a setting of the video display device in control command reception success state.

An automatic recovery method for a video display system according to an aspect of the present invention is an automatic recovery method for a video display system including a plurality of video display devices and a control system configured to control the plurality of video display devices, the automatic recovery method including: storing a log when the own video display device receives a control command transmitted from the control system, in a storage area included in each of the plurality of video display devices; and monitoring the logs stored in the storage areas of the other video display devices by a monitor included in each of the plurality of video display devices, and further including, when the monitor recognizes that the log corresponding to the logs stored in the storage areas of the other video display devices is not stored in the storage area of the own video display device, requesting, by a video display device in control command reception failure state that is a video display device recognized as not having the stored log corresponding to the other video display devices, a video display device in control command reception success state that is a video display device other than the video display device in control command reception failure state among the plurality of video display devices to transmit the control command received by the video display device in control command reception success state, recovering from a control command reception failure state using the control command transmitted from the video display device in control command reception success state to the video display device in control command reception failure state, and making a setting of the video display device in control command reception failure state the same as a setting of the video display device in control command reception success state.

### Advantageous Effects of Invention

According to the present invention, when there is a video display device requiring recovery among a plurality of video display devices controlled by a control system, it is possible to appropriately perform recovery of the video display device.

### BRIEF DESCRIPTION OF DRAWINGS

FIG. 1 A diagram illustrating an example of a video display system 1 of a first embodiment.

FIG. 2 A diagram illustrating an example of a connection relationship between video display devices 11A, 11B, and 11C and a control system 12 illustrated in FIG. 1.

FIG. 3 A diagram illustrating an example of a case where the control system 12 illustrated in FIG. 2 transmits the same control command X to the video display devices 11A, 11B, and 11C to collectively control the video display devices 11A, 11B, and 11C.

FIG. 4 A diagram illustrating an example in which a video display device 11A monitors a command reception log stored in a storage area 112 of the video display device 11B and a command reception log stored in a storage area 112 of the video display device 11C via a network NW.

FIG. 5 A diagram illustrating an example in which the video display device 11C monitors a command reception log stored in a storage area 112 of the video display device 11A and the command reception log stored in the storage area 112 of the video display device 11B via the network NW.

FIG. 6 A diagram illustrating an example of recovery processing for the video display device 11C that is executed by a processor 114 of the video display device 11C.

FIG. 7 A diagram illustrating an example of a command and an instruction transmitted from the control system 12 and a signal transmitted from a video signal source 13 when settings of the video display devices 11A, 11B, and 11C are changed by changing video signals input to the video display devices 11A, 11B, and 11C.

FIG. 8 A diagram illustrating another example of the case where the settings of the video display devices 11A, 11B, and 11C are changed by changing the video signals input to the video display devices 11A, 11B, and 11C.

FIG. 9 A diagram illustrating another example in which the video signal input to the video display device 11C is changed.

FIG. 10 A flowchart showing an example of processing that is executed, for example, in the video display device 11C of the video display system 1 of the first embodiment.

### DESCRIPTION OF EMBODIMENTS

Hereinafter, an embodiment of a video display system and an automatic recovery method for the video display system of the present invention will be described with reference to the drawings.

### First Embodiment

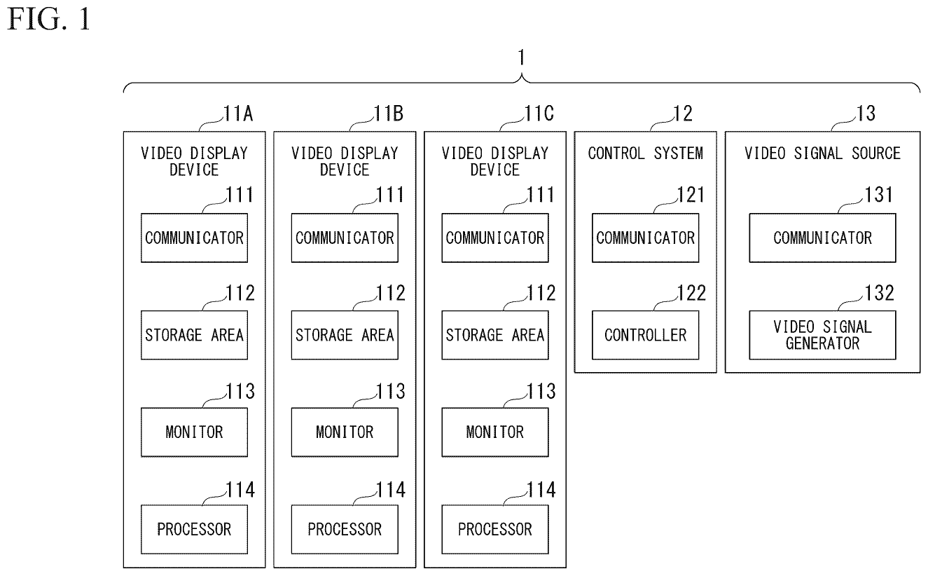

FIG. 1 is a diagram illustrating an example of a video display system 1 of a first embodiment.

In the example illustrated in FIG. 1, the video display system 1 includes a video display device 11A, a video display device 11B, a video display device 11C, a control system 12, and a video signal source 13.

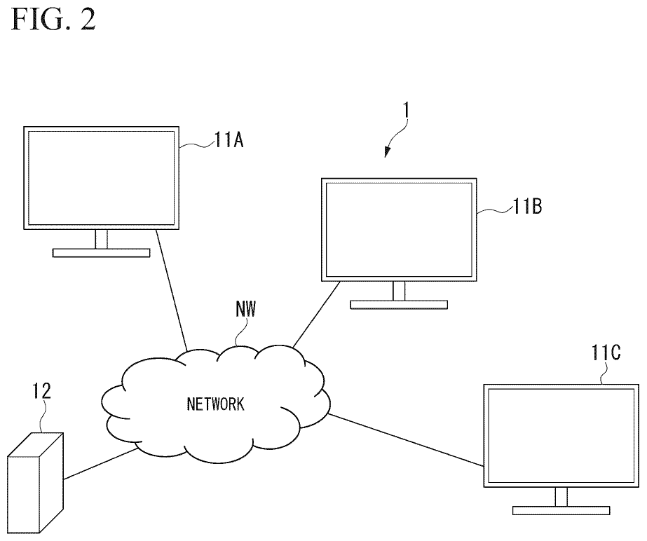

The video display device 11A displays a video on a screen of the video display device 11A (see FIG. 2 or the like) based on a video signal input to the video display device 11A. The video display device 11A includes a communicator 111, a storage area 112, a monitor 113, and a processor 114.

The communicator 111 of the video display device 11A performs communication with the control system 12, the video display device 11B, the video display device 11C, and the like.

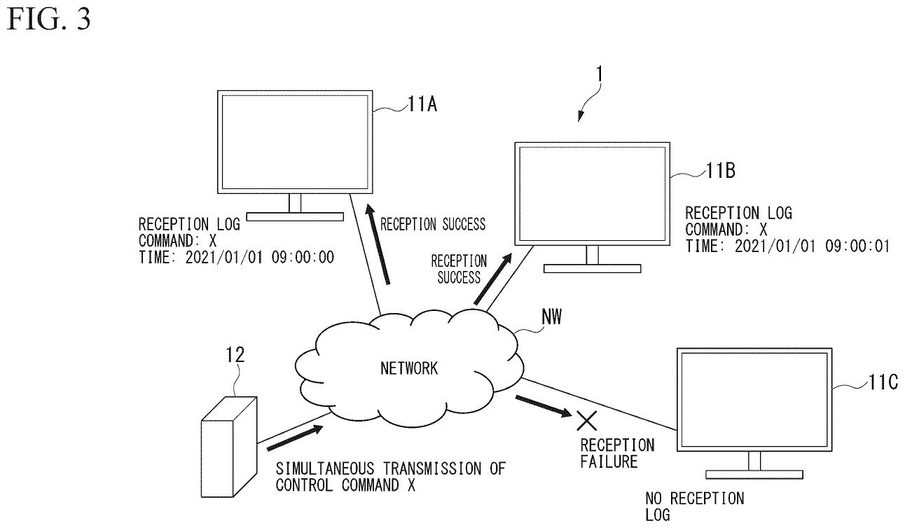

The storage area 112 of the video display device 11A stores the content of the communication between the video display device 11A and the control system 12, the content of the communication between the video display device 11A and the video display device 11B, the content of the communication between the video display device 11A and the video display device 11C, and the like. The content of the communication between the video display device 11A and the control system 12 includes, for example, commands such as the control command X (see FIG. 3) that the video display device 11A has received from the control system 12. The content of the communication between the video display device 11A and the video display device 11B includes, for example, a request from the video display device 11A to the video display device 11B for the control command X that the video display device 11B has received from the control system 12, and the control command X that the video display device 11B has transmitted to the video display device 11A in response to the request from the video display device 11A. The content of the communication between the video display device 11A and the video display device 11C includes, for example, a request from the video display device 11A to the video display device 11C for the control command X that the video display device 11C has received from the control system 12, and the control command X that the video display device 11C has transmitted to the video display device 11A in response to the request from the video display device 11A.

The storage area 112 of the video display device 11A also stores a log (command reception log) when the video display device 11A (its own video display device) receives the control command transmitted from the control system 12. The command reception log of the video display device 11A includes, for example, a command such as the control command X that the video display device 11A has received from the control system 12, and a time when the video display device 11A has received the command.

The monitor 113 of the video display device 11A monitors the command reception logs stored in the storage areas 112 of the other video display devices 11. For example, the monitor 113 of the video display device 11A monitors the command reception log stored in the storage area 112 of the video display device 11B and the command reception log stored in the storage area 112 of the video display device 11C. The command reception log of the video display device 11B includes, for example, a command such as the control command X that the video display device 11B has received from the control system 12, and a time when the video display device 11B has received the command. The command reception log of the video display device 11C includes, for example, a command such as the control command X that the video display device 11C has received from the control system 12, and a time when the video display device 11C has received the command.

The processor 114 of the video display device 11A performs processing such as recovery and setting change on the video display device 11A.

In the example illustrated in FIG. 1, the video display device 11B and the video display device 11C are configured in the same manner as the video display device 11A.

In another example, configurations of the video display device 11A, the video display device 11B, and the video display device 11C may be different from each other, or the configuration of any one of the video display device 11A, the video display device 11B, and the video display device 11C may be different from the configurations of the two other video display devices.

In the example illustrated in FIG. 1, the communicator 111 of the video display device 11B performs communication with the control system 12, the video display device 11A, the video display device 11C, and the like.

The storage area 112 of the video display device 11B stores content of the communication between the video display device 11B and the control system 12, content of the communication between the video display device 11B and the video display device 11A, content of the communication between the video display device 11B and the video display device 11C, and the like. The content of the communication between the video display device 11B and the control system 12 includes, for example, commands such as the control command X received from the control system 12 by the video display device 11B. The content of the communication between the video display device 11B and the video display device 11A includes, for example, a request from the video display device 11B to the video display device 11A for the control command X that the video display device 11A has received from the control system 12, and the control command X that the video display device 11A has transmitted to the video display device 11B in response to the request from the video display device 11B. The content of the communication between the video display device 11B and the video display device 11C includes, for example, a request from the video display device 11B to the video display device 11C for the control command X that the video display device 11C has received from the control system 12, and the control command X that the video display device 11C has transmitted to the video display device 11B in response to the request from the video display device 11B.

The storage area 112 of the video display device 11B also stores a log (command reception log) when the video display device 11B (the own video display device) has received the control command transmitted from the control system 12.

The monitor 113 of the video display device 11B monitors the command reception logs stored in the storage areas 112 of the other video display devices 11. For example, the monitor 113 of the video display device 11B monitors the command reception log stored in the storage area 112 of the video display device 11A and the command reception log stored in the storage area 112 of the video display device 11C.

The processor 114 of the video display device 11B performs processing such as recovery and setting change on the video display device 11B.

The communicator 111 of the video display device 11C performs communication with the control system 12, the video display device 11A, the video display device 11B, or the like.

The storage area 112 of the video display device 11C stores the content of the communication between the video display device 11C and the control system 12, the content of the communication between the video display device 11C and the video display device 11A, the content of the communication between the video display device 11C and the video display device 11B, or the like. The content of the communication between the video display device 11C and the control system 12 includes, for example, a command such as the control command X that the video display device 11C has received from the control system 12. The content of the communication between the video display device 11C and the video display device 11A includes, for example, a request from the video display device 11C to the video display device 11A for the control command X that the video display device 11A has received from the control system 12, and the control command X that the video display device 11A has transmitted to the video display device 11C in response to the request from the video display device 11C. The content of the communication between the video display device 11C and the video display device 11B includes, for example, a request from the video display device 11C to the video display device 11A for the control command X that the video display device 11B has received from the control system 12, and the control command X that the video display device 11B has transmitted to the video display device 11C in response to the request from the video display device 11C.

Further, the storage area 112 of the video display device 11C stores a log (command reception log) when the video display device 11C (the own video display device) receives the control command transmitted from the control system 12.

The monitor 113 of the video display device 11C monitors the command reception logs stored in the storage areas 112 of the other video display devices 11. For example, the monitor 113 of the video display device 11C monitors the command reception log stored in the storage area 112 of the video display device 11A and the command reception log stored in the storage area 112 of the video display device 11B.

The processor 114 of the video display device 11C performs processing such as recovery and setting change on the video display device 11C.

In the example illustrated in FIG. 1, the control system 12 performs, for example, control of the video display devices 11A, 11B, and 11C. The control system 12 includes a communicator 121 and a controller 122.

The communicator 121 performs communication with the video display devices 11A, 11B, and 11C. The controller 122 controls the video display devices 11A, 11B, and 11C. For example, the communicator 121 of the control system 12 transmits the same control command X to the video display devices 11A, 11B, and 11C, and the controller 122 collectively controls the video display devices 11A, 11B, and 11C.

The video signal source 13 generates video signals to be input to the video display devices 11A, 11B, and 11C. The video signal source 13 includes a communicator 131 and a video signal generator 132. The communicator 131 performs communication with the control system 12, the video display devices 11A, 11B, and 11C, or the like. The video signal generator 132 generates the video signals to be input to the video display devices 11A, 11B, and 11C. Further, the video signal generator 132 has a function of changing the video signals to be input to the video display devices 11A, 11B, and 11C in response to an instruction from the control system 12.

FIG. 2 is a diagram illustrating an example of a connection relationship between the video display devices 11A, 11B, and 11C and the control system 12 illustrated in FIG. 1.

In the example illustrated in FIG. 2, the video display devices 11A, 11B, and 11C and the control system 12 are connected to each other via a network NW.

FIG. 3 is a diagram illustrating an example of a case where the control system 12 illustrated in FIG. 2 transmits the same control command X to the video display devices 11A, 11B, and 11C to collectively control the video display devices 11A, 11B, and 11C.

In the example illustrated in FIG. 3, the control system 12 transmits the same control command X to the video display devices 11A, 11B, and 11C to collectively control the video display devices 11A, 11B, and 11C (specifically, to simultaneously change the settings of the video display devices 11A, 11B, and 11C).

In the example illustrated in FIG. 3, information indicating that the control command X is transmitted simultaneously to the video display devices 11A, 11B, and 11C is included in the control command X. In another example, the information indicating that the control command X is transmitted simultaneously to the video display devices 11A, 11B, and 11C may be transmitted from the control system 12 to the video display devices 11A, 11B, and 11C separately from the control command X.

In the example illustrated in FIG. 3, the video display device 11A successfully receives the control command X transmitted from the control system 12, and the processor 114 of the video display device 11A changes a setting value of the video display device 11A based on the control command X. Further, the video display device 11A stores the control command X transmitted from the control system 12 and a reception time of the control command X (Jan. 1, 2021 09:00:00) as the command reception log in the storage area 112 of the video display device 11A.

The video display device 11B successfully receives the control command X transmitted from the control system 12, and the processor 114 of the video display device 11B changes the setting value of the video display device 11B based on the control command X. Further, the video display device 11B stores the control command X transmitted from the control system 12 and the reception time of the control command X (Jan. 1, 2021 09:00:01) as the command reception log in the storage area 112 of the video display device 11B.

On the other hand, the video display device 11C fails to receive the control command X transmitted from the control system 12.

In the example illustrated in FIG. 3, regardless of whether the video display device 11C fails to receive the control command X transmitted from the control system 12, the video display device 11A periodically monitors the command reception log stored in the storage area 112 of the video display device 11B and the command reception log stored in the storage area 112 of the video display device 11C via the network NW, the video display device 11B periodically monitors the command reception log stored in the storage area 112 of the video display device 11A and the command reception log stored in the storage area 112 of the video display device 11C via the network NW, and the video display device 11C periodically monitors the command reception log stored in the storage area 112 of the video display device 11A and the command reception log stored in the storage area 112 of the video display device 11B via the network NW.

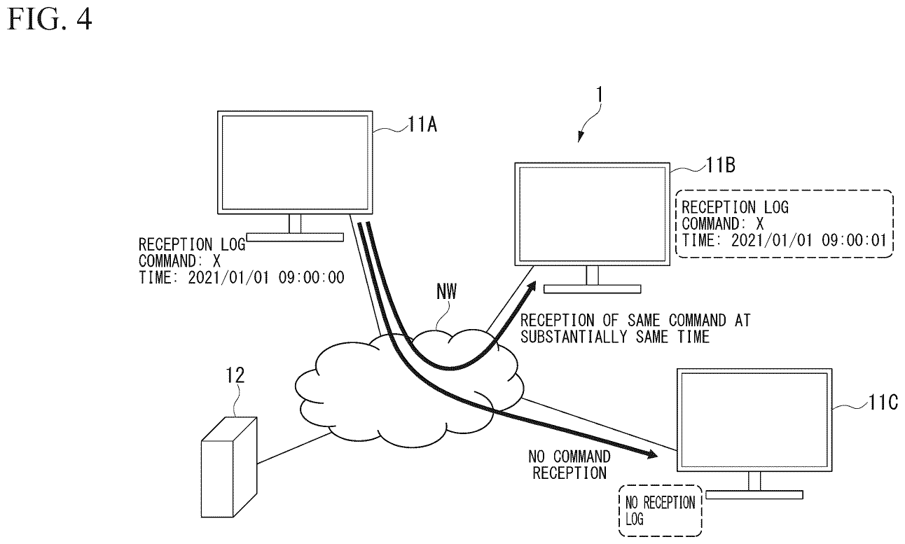

FIG. 4 is a diagram illustrating an example in which the video display device 11A monitors the command reception log stored in the storage area 112 of the video display device 11B and the command reception log stored in the storage area 112 of the video display device 11C via the network NW.

In the example illustrated in FIG. 4, the monitor 113 of the video display device 11A monitors the command reception log stored in the storage area 112 of the video display device 11B and the command reception log stored in the storage area 112 of the video display device 11C via the network NW. As a result, based on the command reception log (the control command X and the reception time of the control command X (Jan. 1, 2021 09:00:00)) stored in the storage area 112 of the video display device 11A and the command reception log (the control command X and the reception time of the control command X (Jan. 1, 2021 09:00:01)) stored in the storage area 112 of the video display device 11B, the video display device 11A recognizes that the video display device 11A and the video display device 11B have received the same control command X at substantially the same time.

Since the video display device 11A has already changed the setting value of the video display device 11A based on the control command X, the video display device 11A does not perform any further change of the setting value based on the results of monitoring by the video display device 11A.

In the example illustrated in FIG. 4, because a difference between a time when the control command X is received by the video display device 11A and a time when the control command X is received by the video display device 11B is within 5 seconds, the video display device 11A recognizes that the time when the control command X is received by the video display device 11A and the time when the control command X is received by the video display device 11B are the same.

In another example, when a difference between the time when the control command X is received by the video display device 11A and the time when the control command X is received by the video display device 11B is within any threshold other than 5 seconds (for example, a value set according to the system or environment, such as 10 seconds), the video display device 11A may recognize that the time when the control command X is received by the video display device 11A and the time when the control command X is received by the video display device 11B are the same.

In the example illustrated in FIG. 4, the video display device 11A recognizes that a command reception log corresponding to the command reception log (the control command X and the reception time of the control command X (Jan. 1, 2021 09:00:00)) stored in the storage area 112 of the video display device 11A is not stored in the storage area 112 of the video display device 11C, but does not take any action such as notifying the video display device 11C of a result of the recognition.

Although not shown, the monitor 113 of the video display device 11B monitors the command reception log stored in the storage area 112 of the video display device 11A and the command reception log stored in the storage area 112 of the video display device 11C via the network NW. As a result, based on the command reception log (the control command X and the reception time of the control command X (Jan. 1, 2021 09:00:01)) stored in the storage area 112 of the video display device 11B and the command reception log (the control command X and the reception time of the control command X (Jan. 1, 2021 09:00:00)) stored in the storage area 112 of the video display device 11A, the video display device 11B recognizes that the video display device 11B and the video display device 11A have received the same control command X at substantially the same time.

Since the video display device 11B has already changed the setting value of the video display device 11B based on the control command X, the video display device 11B does not perform any further change on the setting value based on the result of monitoring of the video display device 11B.

Further, the video display device 11B recognizes that the command reception log (the control command X and the reception time of the control command X (Jan. 1, 2021 09:00:01)) stored in the storage area 112 of the video display device 11B is not stored in the storage area 112 of the video display device 11C, but the video display device 11B does not take any action such as notifying the video display device 11C of a result of the recognition.

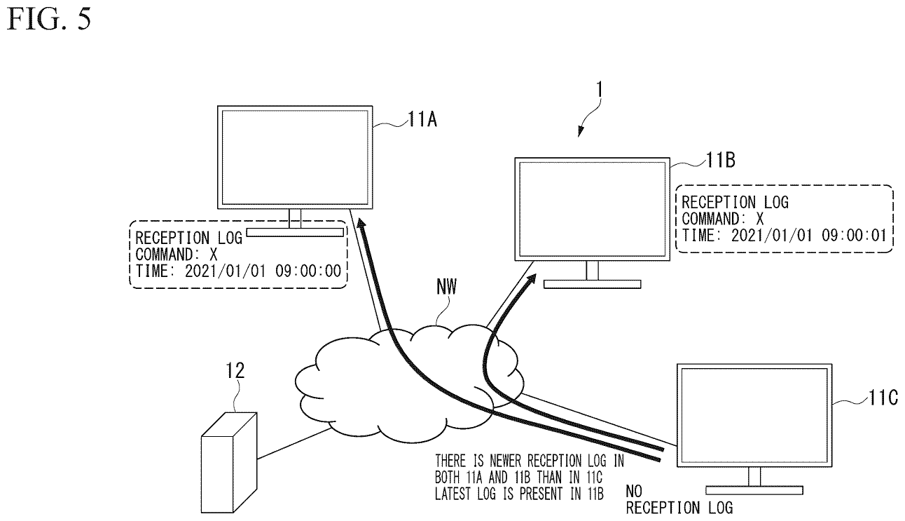

FIG. 5 is a diagram illustrating an example in which the video display device 11C monitors the command reception log stored in the storage area 112 of the video display device 11A and the command reception log stored in the storage area 112 of the video display device 11B via the network NW.

In the example illustrated in FIG. 5, the monitor 113 of the video display device 11C monitors the command reception log stored in the storage area 112 of the video display device 11A and the command reception log stored in the storage area 112 of the video display device 11B via the network NW. As a result, the video display device 11C recognizes that the command reception log corresponding to the command reception log (the control command X and the reception time of the control command X (Jan. 1, 2021 09:00:00)) stored in the storage area 112 of the video display device 11A and the command reception log (the control command X and the reception time of the control command X (Jan. 1, 2021 09:00:01)) stored in the storage area 112 of the video display device 11B is not stored in the storage area 112 of the video display device 11C, and recognizes that the video display device 11C has failed to receive the control command X transmitted simultaneously to the video display devices 11A, 11B, and 11C. In this case, the video display device 11 that is recognized as not having a stored command reception log corresponding to other video display devices 11 (the video display devices 11A and 11B), such as video display device 11C, is a “video display device in control command reception failure state.” On the other hand, the video display device 11 that has successfully received the control command X, such as the video display devices 11A and 11B other than the video display device 11C, is a “video display device in control command reception success state.”

Further, the video display device 11C recognizes that a latest command reception log (that is, a command reception log with a latest reception time of the control command X) among the command reception log (the control command X and the reception time of the control command X (Jan. 1, 2021 09:00:00)) stored in the storage area 112 of the video display device 11A and the command reception log (the control command X and the reception time of the control command X (Jan. 1, 2021 09:00:01)) stored in the storage area 112 of the video display device 11B is stored in the storage area 112 of the video display device 11B.

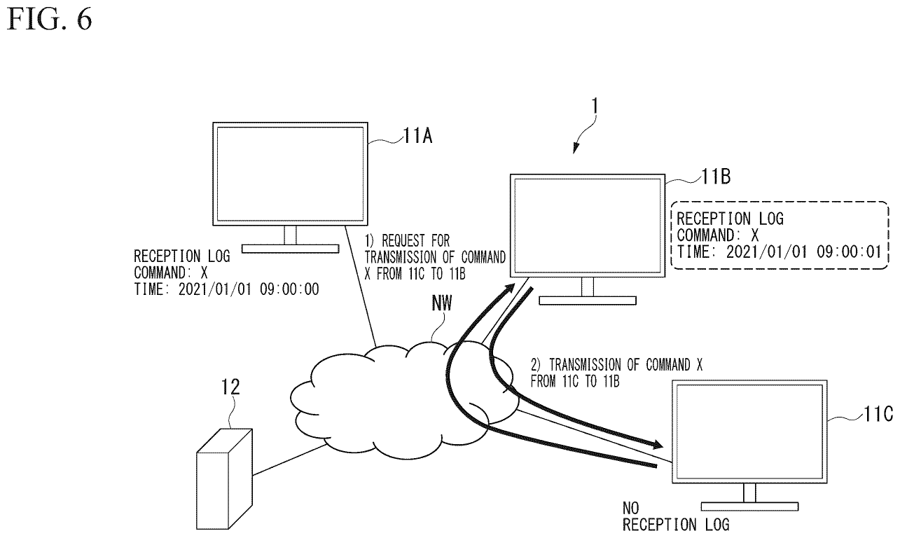

FIG. 6 is a diagram illustrating an example of recovery processing of the video display device 11C that is executed by the processor 114 of the video display device 11C.

In the example illustrated in FIG. 6, the processor 114 of the video display device 11C requests the video display device 11B, which stores the latest command reception log (the control command X and the reception time of the control command X (Jan. 1, 2021 09:00:01)) between the video display devices 11A and 11B that have successfully received the control command X that the video display device 11C could not receive, to transmit the control command X.

Next, in response to the request from the video display device 11C, the video display device 11B transmits the control command X included in the command reception log stored in the storage area 112 of the video display device 11B to the video display device 11C.

Next, the processor 114 of the video display device 11C changes a setting value of the video display device 11C based on the control command X transmitted from the video display device 11B. In other words, the processor 114 of the video display device 11C executes the recovery processing of the video display device 11C using the control command X transmitted from the video display device 11B. As a result, the video display device 11C recovers from a state in which the video display device 11C has failed to receive the control command X, and the setting of the video display device 11C is made the same as those of the video display devices 11A and 11B.

That is, in the example illustrated in FIG. 6, the video display device 11C finds the video display device 11B that has received the control command X at a new time different than a reception time of a command reception log (not shown) that the video display device 11C has, and requests the video display device 11B to transmit the control command X included in the command reception log stored in the storage area 112 of the video display device 11B to the video display device 11C. As a result, even when the video display device 11C fails to receive the control command X transmitted from the control system 12, the video display device 11C can recover from the state in which the video display device 11C fails to receive the control command X transmitted from the control system 12, by using the control command X transmitted from the video display device 11B.

In the example illustrated in FIGS. 1 to 6, the settings of the video display devices 11A, 11B, and 11C are changed by using the control command X transmitted from the control system 12 to the video display devices 11A, 11B, and 11C, but in another example of the video display system 1 of the first embodiment, the settings of the video display devices 11A, 11B, and 11C can also be changed by changing the video signals input to the video display devices 11A, 11B, and 11C.

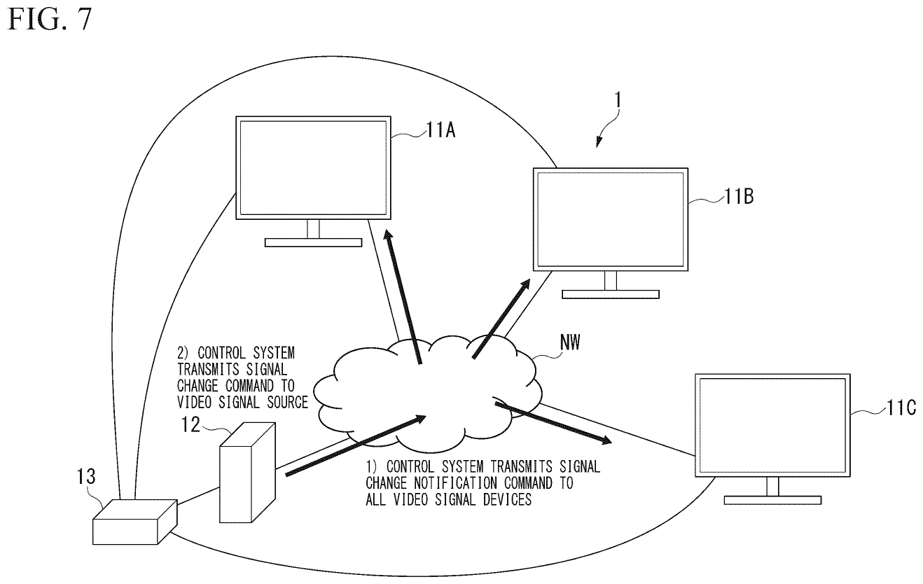

FIG. 7 is a diagram illustrating an example of a command and an instruction transmitted from the control system 12 and a signal transmitted from the video signal source 13 when settings of the video display devices 11A, 11B, and 11C are changed by changing the video signals input to the video display devices 11A, 11B, and 11C.

In the example illustrated in FIG. 7, as in the example illustrated in FIG. 2, the video display devices 11A, 11B, and 11C and the control system 12 are connected to each other via the network NW. Further, the video signal source 13 is connected to each of the video display devices 11A, 11B, and 11C and the control system 12.

In the example illustrated in FIG. 7, the control system 12 transmits the same signal change notification command Y to the video display devices 11A, 11B, and 11C in order to simultaneously change the settings of the video display devices 11A, 11B, and 11C, and also issues a signal change instruction to the video signal source 13, which is an instruction to change the video signal input to the video display devices 11A, 11B, and 11C.

In the example illustrated in FIG. 7, the video display device 11A successfully receives the signal change notification command Y transmitted from the control system 12, and then detects a change in the video signal input to the video display device 11A by the video signal source 13 within a certain period of time. Therefore, the video display device 11A determines that the change in the video signal input to the video display device 11A by the video signal source 13 is intended to change the settings of the video display device 11A. Further, the processor 114 of the video display device 11A changes the setting value of the video display device 11A based on the change in the video signal input to the video display device 11A by the video signal source 13.

In the example illustrated in FIG. 7, the video display device 11B successfully receives the signal change notification command Y transmitted from the control system 12, and then detects a change in the video signal input to the video display device 11B by the video signal source 13 within a certain period of time. Therefore, the video display device 11B determines that the change in the video signal input to the video display device 11B by the video signal source 13 is intended to change the setting of the video display device 11B. Further, the processor 114 of the video display device 11B changes the setting value of the video display device 11B based on the change in the video signal input to the video display device 11B by the video signal source 13.

The video display device 11C successfully receives the signal change notification command Y transmitted from the control system 12, and then detects a change in the video signal input to the video display device 11C by the video signal source 13 within a certain period of time. Therefore, the video display device 11C determines that the change in the video signal input to the video display device 11C by the video signal source 13 is intended to change the setting of the video display device 11C. Further, the processor 114 of the video display device 11C changes the setting value of the video display device 11C based on the change in the video signal input to the video display device 11C by the video signal source 13.

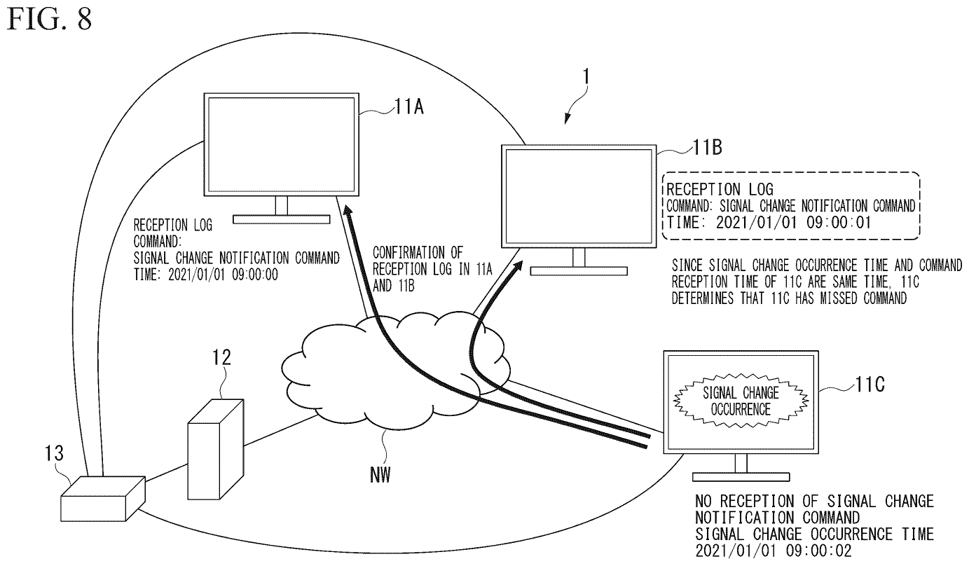

FIG. 8 is a diagram illustrating another example of the case where the settings of the video display devices 11A, 11B, and 11C are changed by changing the video signal input to the video display devices 11A, 11B, and 11C.

In the example illustrated in FIG. 8, as in the example illustrated in FIG. 7, the control system 12 transmits the same signal change notification command Y to the video display devices 11A, 11B, and 11C and also issues to the video signal source 13 a signal change instruction which is an instruction to change the video signal input to the video display devices 11A, 11B, and 11C, in order to simultaneously change the settings of the video display devices 11A, 11B, and 11C.

In the example illustrated in FIG. 8, as in the example illustrated in FIG. 7, the video display device 11A successfully receives the signal change notification command Y transmitted from the control system 12, and then detects a change in the video signal input to the video display device 11A by the video signal source 13 within a certain period of time. Therefore, the video display device 11A determines that the change in the video signal input to the video display device 11A by the video signal source 13 is intended to change the settings of the video display device 11A. Further, the processor 114 of the video display device 11A changes the setting value of the video display device 11A based on the change in the video signal input to the video display device 11A by the video signal source 13.

Also, as in the example illustrated in FIG. 7, the video display device 11B successfully receives the signal change notification command Y transmitted from the control system 12, and then detects a change in the video signal input to the video display device 11B by the video signal source 13 within a certain period of time. Therefore, the video display device 11B determines that the change in the video signal input to the video display device 11B by the video signal source 13 is intended to change the setting of the video display device 11B. Further, the processor 114 of the video display device 11B changes the setting value of the video display device 11B based on the change in the video signal input to the video display device 11B by the video signal source 13.

On the other hand, in the example illustrated in FIG. 8, unlike the example illustrated in FIG. 7, the video display device 11C fails to receive the signal change notification command Y transmitted from the control system 12. Further, the video display device 11C detects a change in the video signal input to the video display device 11C by the video signal source 13.

The video display device 11C needs to determine whether or not the change in the video signal input to the video display device 11C by the video signal source 13 is intended to change the setting of the video display device 11C.

Therefore, the video display device 11C requests the command reception log from the other video display devices 11A and 11B connected to the same network NW (that is, the video display devices 11A and 11B other than the video display device 11C among the video display devices 11A, 11B, and 11C that are targets of collective control of by the control system 12), and confirms the command reception log (the signal change notification command Y and a time when the signal change notification command Y has been received (Jan. 1, 2021 09:00:00)) of the video display device 11A and the command reception log (the signal change notification command Y and a time when the signal change notification command Y has been received (Jan. 1, 2021 09:00:01)) of the video display device 11B.

In the example illustrated in FIG. 8, the video display device 11C detects a change in the video signal input to the video display device 11C by the video signal source 13 at time (Jan. 1, 2021 09:00:02, but does not receive the signal change notification command Y transmitted from the control system 12.

On the other hand, the command reception log of the video display device 11A includes the signal change notification command Y and the time when the signal change notification command Y has been received (Jan. 1, 2021 09:00:00), and the command reception log of the video display device 11B includes the signal change notification command Y and the time when the signal change notification command Y has been received (Jan. 1, 2021 09:00:01).

In other words, the command reception logs of the video display device 11A and video display device 11B store the fact that the video display device 11A has received the signal change notification command Y and the video display device 11B has received the signal change notification command Y at substantially the same time as time (Jan. 1, 2021 09:00:02 when the video display device 11C has detected the change in the video signal input to video display device 11C by the video signal source 13.

Therefore, the video display device 11C determines that the video display device 11C fails to receive the signal change notification command Y that the video display device 11C should have received, and determines that it is necessary to change the setting value of the video display device 11C based on the change in the video signal detected at time Jan. 1, 2021 09:00:02.

Further, the processor 114 of the video display device 11C changes the setting value of the video display device 11C based on a result of that determination and the change in the video signal detected at time (Jan. 1, 2021 09:00:02. As a result, the video display device 11C recovers from a state in which the video display device 11C fails to receive the signal change notification command Y, and the setting of the video display device 11C becomes the same as the settings of the video display devices 11A and 11B.

In the example illustrated in FIG. 8, both of the command reception log (the signal change notification command Y and the time when the signal change notification command Y has been received (Jan. 1, 2021 09:00:00)) of the video display device 11A and the command reception log (the signal change notification command Y and the time when the signal change notification command Y has been received (Jan. 1, 2021 09:00:01)) of the video display device 11B include the signal change notification command Y (that is, both the video display device 11A and the video display device 11B have successfully received the signal change notification command Y).

In other words, in the example illustrated in FIG. 8, when the control system 12 changes the video signal that is input to the video display devices 11A, 11B, and 11C and transmits the same signal change notification command Y to the video display devices 11A, 11B, and 11C to simultaneously change the settings of the video display devices 11A, 11B, and 11C, and when the video display device 11C fails to receive the signal change notification command Y but the video display devices 11A and 11B receive the signal change notification command Y, the video display device 11C determines that the change in the video signal input to the video display device 11C is intended to change the setting of the video display device 11C, based on a result of the confirmation as to whether the video display devices 11A and 11B have received the signal change notification command Y. Further, the video display device 11C changes the setting of the video display device 11C based on the change in the video signal input to the video display device 11C.

In another example, the signal change notification command Y may be included in only any one of the command reception log of the video display device 11A and the command reception log of the video display device 11B (that is, one of the video display device 11A and the video display device 11B may successfully receive the signal change notification command Y, while the other of the video display device 11A and the video display device 11B may fail to receive the signal change notification command Y).

In this example, the video display device 11C also determines that the video display device 11C has failed to receive the signal change notification command Y that the video display device 11C should have received, and determines that it is necessary to change the setting value of the video display device 11C based on the change in the video signal detected at time Jan. 1, 2021 09:00:02. Further, the processor 114 of the video display device 11C changes the setting value of the video display device 11C based on a result of the determination and the change in the video signal detected at time Jan. 1, 2021 09:00:02. As a result, the video display device 11C recovers from the state where the video display device 11C has failed to receive the signal change notification command Y, and the setting of the video display device 11C is made the same as the setting of the video display device that has successfully received the signal change notification command Y among the video display devices 11A and 11B.

In this example, the other video display device that has failed to receive the signal change notification command Y among the video display devices 11A and 11B also executes the same recovery processing as the video display device 11C.

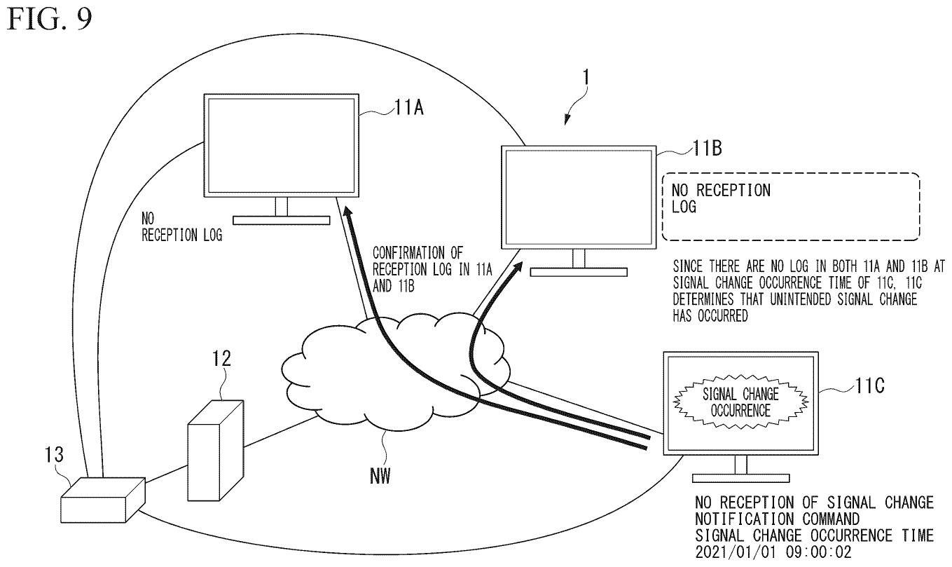

FIG. 9 is a diagram illustrating another example in which the video signal input to the video display device 11C changes.

In the example illustrated in FIG. 9, the control system 12 does not intend to change the settings of the video display devices 11A, 11B, and 11C. Therefore, the control system 12 does not transmit the signal change notification command Y to the video display devices 11A, 11B, and 11C. Further, the control system 12 does not issue an instruction (signal change instruction) to the video signal source 13 to change the video signal input to the video display devices 11A, 11B, and 11C.

As a result, in the example illustrated in FIG. 9, no command reception log is stored in the storage area 112 of the video display device 11A, and the video signal input to the video display device 11A by the video signal source 13 does not change.

Further, no command reception log is stored in the storage area 112 of the video display device 11B, and the video signal input to the video display device 11B by the video signal source 13 does not change.

In the example illustrated in FIG. 9, no command reception log is stored in the storage area 112 of the video display device 11C as in the video display devices 11A and 11B, but the video signal input to the video display device 11C by the video signal source 13 changes due to noise or the like.

In the example illustrated in FIG. 9, the video display device 11C needs to determine whether the change in the video signal input to the video display device 11C by the video signal source 13 is intended to change the setting of the video display device 11C or is not intended to change the setting of the video display device 11C (in other words, whether the video signal input to the video display device 11C has changed due to noise or the like), as in the example illustrated in FIG. 8.

Therefore, in the example illustrated in FIG. 9, the video display device 11C requests the command reception log from the video display devices 11A and 11B other than the video display device 11C among the video display devices 11A, 11B, and 11C that are targets of collective control of the control system 12, and confirms that there is no command reception log of the video display device 11A and that there is no command reception log of the video display device 11B, as in the example illustrated in FIG. 8.

As a result, the video display device 11C determines that the change in the video signal detected at (Jan. 1, 2021 09:00:02 is not intended to change the setting value of the video display device 11C, but is caused by noise or the like.

The processor 114 of the video display device 11C does not change the setting value of the video display device 11C based on a result of this determination.

When the setting value of the video display device 11C has already been changed, the video display device 11C confirms current settings of the video display devices 11A and 11B via the network NW, and makes the setting of the video display device 11C the same as those of the video display devices 11A and 11B. In other words, the setting of the video display device 11C are recovered.

In other words, in the example illustrated in FIG. 9, when the video display device 11C among the video display devices 11A, 11B, and 11C detects a change in the video signal input to the video display device 11C, and the video display devices 11A and 11B other than the video display device 11C among the video display devices 11A, 11B, and 11C do not receive the signal change notification command Y corresponding to the change in the video signal input to the video display device 11C, the video display device 11C determines that the change in the video signal input to the video display device 11C is not intended to change the setting of the video display device 11C based on a result of the confirmation as to whether the video display devices 11A and 11B other than the video display device 11C among the video display devices 11A, 11B, and 11C have received the signal change notification command Y.

When the video display device 11C determines that the change in the video signal input to the video display device 11C is not intended to change the setting of the video display device 11C, the video display device 11C confirms the current settings of the video display devices 11A and 11B other than the video display device 11C among the video display devices 11A, 11B, and 11C. Further, the video display device 11C makes the setting of the video display device 11C the same as the setting of the video display device 11A or 11B other than the video display device 11C among the video display devices 11A, 11B, and 11C.

In another example, as in the example illustrated in FIG. 9, the control system 12 does not intend to change the settings of the video display devices 11A, 11B, and 11C. Therefore, the control system 12 does not transmit the signal change notification command Y to the video display devices 11A, 11B, and 11C. Further, the control system 12 does not issue an instruction (signal change instruction) to the video signal source 13 to change the video signal input to the video display devices 11A, 11B, and 11C.

In this example, a past command reception log (that is, a command reception log stored at a timing different from a timing at which the video signal input to the video display device 11C changes) is stored in the storage area 112 of the video display device 11A, unlike the example illustrated in FIG. 9.

Further, the past command reception log is also stored in the storage area 112 of the video display device 11B.

In this example, the video signal input to the video display device 11C by the video signal source 13 changes due to noise or the like, as in the example illustrated in FIG. 9.

In this example, the video display device 11C also needs to determine whether the change in the video signal input to the video display device 11C by the video signal source 13 is intended to change the setting of the video display device 11C or is not intended to change the setting of the video display device 11C (that is, the video signal input to the video display device 11C has changed due to noise or the like).

Therefore, in this example, the video display device 11C requests the command reception log from the video display devices 11A and 11B other than the video display device 11C among the video display devices 11A, 11B, and 11C that are targets of collective control of the control system 12, and confirms that only a past command reception log is stored in the storage area 112 of the video display device 11A, and that only a past command reception log is stored in the storage area 112 of the video display device 11B.

As a result, the video display device 11C determines that the change in the video signal detected at Jan. 1, 2021 09:00:02 is not intended to change the setting value of the video display device 11C, but is caused by noise or the like.

The processor 114 of the video display device 11C does not change the setting value of the video display device 11C based on a result of this determination.

In this example, when the setting value of the video display device 11C has already been changed, the video display device 11C confirms the current settings of the video display devices 11A and 11B via the network NW, and makes the setting of the video display device 11C the same as those of the video display devices 11A and 11B, as in the example illustrated in FIG. 9. In other words, recovery of the setting of the video display device 11C is performed.

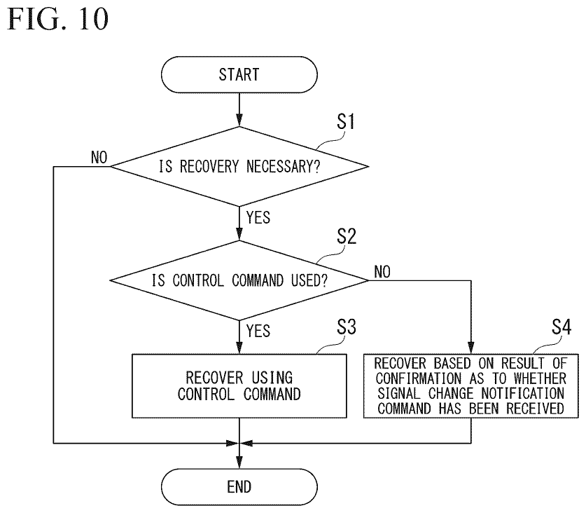

FIG. 10 is a flowchart illustrating an example of a process that is executed in, for example, the video display device 11C of the video display system 1 of the first embodiment.

In the example illustrated in FIG. 10, in step S1, the video display device 11C determines whether recovery of the video display device 11C (that is, recovery of itself) is necessary. When the recovery of itself is necessary, the process proceeds to step S2. On the other hand, when the recovery of itself is not necessary, a routine illustrated in FIG. 10 ends.

In step S2, the video display device 11C determines whether to perform recovery of itself using the control command X. That is, in step S2, the video display device 11C determines whether or not the video display device 11C (that is, itself) has failed to receive the control command X when the control system 12 transmits the same control command X to the video display devices 11A, 11B, and 11C to collectively control the video display devices 11A, 11B, and 11C.

In a case where the video display device 11C performs recovery of itself using the control command X, that is, in a case where the video display device 11C has failed to receive the control command X when the control system 12 transmits the same control command X to the video display devices 11A, 11B, and 11C to collectively control the video display devices 11A, 11B, and 11C, the process proceeds to step S3.

On the other hand, in a case where the video display device 11C does not perform the recovery of itself using the control command X, and, specifically, in a case where the video display device 11C fails to receive the signal change notification command Y when the control system 12 changes the video signal that is input to the video display devices 11A, 11B, and 11C and transmits the same signal change notification command Y to the video display devices 11A, 11B, and 11C to simultaneously change the settings of the video display devices 11A, 11B, and 11C, the process proceeds to step S4.

In step S3, the video display device 11C that has failed to receive the control command X requests the video display device that has received the control command X (that is, the video display device 11A or the video display device 11B) to transmit the control command X received by one of the video display devices 11A and 11B other than video display device 11C among the video display devices 11A, 11B, and 11C. Further, the video display device 11C recovers from a state in which the video display device 11C has failed to receive the control command X by using the control command X transmitted from the video display device that has received the control command X (that is, the video display device 11A or the video display device 11B) to the video display device 11C.

In step S4, the video display device 11C that has failed to receive the signal change notification command Y confirms whether the video display devices 11A and 11B other than the video display device 11C among the video display devices 11A, 11B, and 11C have received the signal change notification command Y. Further, the video display device 11C makes the setting of the video display device 11C the same as the settings of the video display devices 11A and 11B, based on a result of the confirmation as to whether the video display devices 11A and 11B have received the signal change notification command Y.

### Second Embodiment

Hereinafter, a second embodiment of the video display system and the automatic recovery method for the video display system of the present invention will be described.

A video display system 1 of the second embodiment is configured in the same way as the video display system 1 of the first embodiment described above, except for points to be described below. Therefore, the video display system 1 of the second embodiment can achieve the same effects as the video display system 1 of the first embodiment described above, except for points to be described below.

As described above, the video display system 1 of the first embodiment includes the three video display devices 11A, 11B, and 11C.

On the other hand, the video display system 1 of the second embodiment includes any number (but a plurality) of video display devices rather than three video display devices.

In an environment where a plurality of video display devices are installed, such as a video wall, the video display devices and a control system may be disposed on the same network, and the plurality of video display devices may be controlled collectively by sending control commands from the control system to the video display devices. In this case, even though the control system transmits the same control command to all the video display devices, some of the video display devices may fail to receive the control command due to factors such as noise or under a situation where the video display devices themselves cannot receive the control command, and may not operate as intended by the control system.

In such a case, according to the video display system 1 of the first or second embodiment, it is possible to automatically recover the video display device that has failed to receive the control command, to a state originally set by receiving the control command.

Further, the video display device may change its setting according to not only the change in the video signal input to the video display device, but also the reception of the control command. In an environment where a plurality of video display devices have been installed, when the same video signal should be input to all the video display devices, an unstable signal input to a certain video display device may cause an unintended change in the setting in the video display device.

In such a case, according to the video display system 1 of the first or second embodiment, it is possible to set the setting of the video display device where unintended setting change has occurred to be the same as those of other surrounding video display devices to which signals are stably input, that is, to return to a setting before the unintended setting change occurs.

Although the forms for implementing the present invention have been described above using the embodiments, the present invention is not limited to these embodiments, and various modifications and substitutions can be made without departing from the gist of the present invention. The configurations described in the above-described embodiments and examples may be combined appropriately.

All or some of functions of the respective elements of the video display system 1 in the above-described embodiment may be realized by recording a program for realizing these functions on a computer-readable recording medium, reading the program recorded on the recording medium into a computer system, and executing the program. It is assumed that the term “computer system” here includes an OS and hardware such as peripheral devices.

Further, the term “computer-readable recording medium” refers to a portable medium such as a flexible disk, an optical magnetic disk, a ROM, and a CD-ROM, and a storage such as hard disks built into the computer system. The term “computer-readable recording medium” may also include a medium that dynamically holds a program for a short period of time, such as a communication line when the program is transmitted via a network such as the Internet or a communication line such as a telephone line, and a medium that holds a program for a certain period of time, such as a volatile memory inside a computer system that is a server or client in such a case. Further, the program may be intended to realize some of the above-described functions, or may be able to realize the above-described functions in combination with a program already recorded in the computer system.

### REFERENCE SIGNS LIST

1 Video display system
11A Video display device
11B Video display device
11C Video display device
111 Communicator
112 Storage area
113 Monitor
114 Processor
12 Control system
121 Communicator
122 Controller
13 Video signal source
131 Communicator
132 Video signal generator
NW Network
X Control command
Y Signal change notification command

What is calimed is:

1. A video display system comprising:
a plurality of video display devices; and
a control system configured to control the plurality of video display devices,
wherein a video display device of the plurality of video display devices comprises:
a storage area configured to store a log when the video display device receives a control command transmitted from the control system; and
a monitor configured to monitor the logs stored in the storage areas of the other video display devices, and
when the monitor recognizes that the log corresponding to the logs stored in the storage areas of the other video display devices is not stored in the storage area of the own video display device,
a video display device in a control command reception failure state that is a video display device recognized as not having the stored log corresponding to the other video display devices, is configured to:
request a video display device in control command reception success state that is a video display device other than the video display device in control command reception failure state among the plurality of video display devices, to transmit the control command received by the video display device in control command reception success state,
recover the video display device from the control command reception failure state, using the control command, wherein the control command has been transmitted from a video display device in a control command reception success state among the plurality of video display devices to a video display device in the control command reception failure state among the plurality of video display devices, and
make a same setting to the video display device in the control command reception failure state as a setting made to the video display device in the control command reception success state.

2. The video display system according to claim 1, wherein
when the control system changes a video signal that is input into the plurality of video display devices and simultaneously changes the settings of the plurality of video display devices by transmitting the same signal change notification command to the plurality of video display devices, and when at least video display device of the plurality of video display devices fail to receive the signal change notification command,
the at least video display device, of the plurality of video display devices, which has failed to receive the signal change notification command, is placed into a signal change notification command reception failure state, and
the at least video display device in the signal change notification command reception failure state is configured to:
confirm whether other video display devices than the at least video display device in the signal change notification command reception failure state among the plurality of video display devices have received the signal change notification command, and
make a same setting to the at least video display device in the signal change notification command reception failure state as settings to the other video display devices, which have received the signal change notification command, wherein the same setting is made based on a result of the confirmation as to whether the other video display devices have received the signal change notification command.

3. The video display system according to claim 2, wherein
when the control system changes the video signal that is input to the plurality of video display devices and transmits the same signal change notification command to the plurality of video display devices to simultaneously change the settings of the plurality of video display devices, and when the video display device in the signal change notification command reception failure state fails to receive the signal change notification command and the other video display devices in the signal change notification command reception suncess state receive the signal change notification command,
the video display device in the signal change notification command reception failure state is configured to:
determine that the change in the video signal input to the video display device in the signal change notification command reception failure state is to change the setting to the video display device in the signal change notification command reception failure state, based on the result of the confirmation as to whether the other video display devices in the signal change notification command reception suncess state have received the signal change notification command, and
change the setting to the video display device in the signal change notification command reception failure state based on the change in the video signal input to the video display device in the signal change notification command reception failure state.

4. The video display system according to claim 2, wherein
when one of the plurality of video display devices detects a change in a video signal input to the one video display device, and when a video display device other than the one video display device among the plurality of video display devices does not receive the signal change notification command corresponding to the change in the video signal input to the one video display device,
the one video display device is configured to determine that the change in the video signal input to the one video display device is not to change a setting of the one video display device based on a result of confirmation as to whether or not the video display device other than the one video display device among the plurality of video display devices has received the signal change notification command.

5. The video display system according to claim 4, wherein
when the one video display device determines that the change in the video signal input to the one video display device is not to change the setting of the one video display device,
the one video display device is configured to:
confirm a current setting of the video display device other than the one video display device among the plurality of video display devices, and
makes the same setting of the one video display device as the setting of the video display device other than the one video display device among the plurality of video display devices.

6. An automatic recovery method for a video display system including a plurality of video display devices and a control system configured to control the plurality of video display devices, the automatic recovery method comprising:
storing a log when a video display device of the plurality of video display devices receives a control command transmitted from the control system, in a storage area included in each of the plurality of video display devices; and
monitoring the logs stored in the storage areas of the other video display devices by a monitor included in each of the plurality of video display devices, and further comprising
when the monitor recognizes that the log corresponding to the logs stored in the storage areas of the other video display devices is not stored in the storage area of the own video display device,
requesting, by a video display device in a control command reception failure state as not having the stored log corresponding to the other video display devices, a video display device in a control command reception success state other than the video display device in the control command reception failure state among the plurality of video display devices to transmit the control command received by the video display device in the control command reception success,
recovering from the video display device in a control command reception failure state, using the control command transmitted from the video display device in the control command reception success state to the video display device in the video display device in control command reception failure state, and
making a same setting to the video display device in the control command reception failure state as a setting made to the video display device in the control command reception success state.
